(19) United States
(12) Patent Application Publication
(10) Pub. No.: US 2025/0363975 A1
(43) Pub. Date: Nov. 27, 2025

(54) ACTIVE NOISE CANCELLATION WITH TRANSPARENT MODE

(71) Applicant: Harman Becker Automotive Systems GmbH, Karlsbad (DE)

(72) Inventors: Heiko Gernot PANTHER, Karlsbad (DE); Paul Matthew STEPHENS, Karlsbad (DE)

(21) Appl. No.: 19/209,605

(22) Filed: May 15, 2025

(30) Foreign Application Priority Data
May 21, 2024 (EP) 24176941

(51) Int. Cl. G10K 11/178; G10L 25/78; H04R 1/10

(52) U.S. Cl. CPC G10K 11/17827; G10K 11/17885; G10L 25/78; H04R 1/1041; H04R 1/1083; G10K 2210/1081; G10K 2210/3036; H04R 2460/01

(57) ABSTRACT

A method and system for operating at least two noise cancelling headphones, each headphone being switchable between a noise cancelling mode of operation and a transparent mode of operation, and each headphone including a microphone, a speech recognition processor and a wireless transceiver. The method includes monitoring sound in the ambience of each headphone picked up by the corresponding microphone for speech using the corresponding speech recognition processor; and monitoring the ambience of each headphone with the corresponding transceiver for a wireless mode control signal. The method includes switching the one of the headphones into the transparent mode of operation and sending the wireless mode control signal from the one of the headphones to at least one other of the headphones using the transceivers if speech is recognized in the picked up sound of one of the headphones. The method further includes switching the at least one other of the headphones from the noise cancelling mode of operation into the transparent mode of operation if the wireless mode control signal is received by the at least one other of the headphones from one of the other headphones.

### CROSS REFERENCE TO RELATED APPLICATIONS

The present application claims priority to European Patent Application No. 24 176 941.3, entitled ACTIVE NOISE CANCELLATION WITH TRANSPARENT MODE″, and filed on May 21, 2024. The entire contents of the above-listed application(s) are hereby incorporated by reference for all purposes.

### BACKGROUND

The disclosure relates to an active noise cancellation headphone and a method for operating such an active noise cancelling headphone.

To combat unwanted ambient sound, generally referred to as noise, some headphones (herein also referred to as systems) use sound deadening material around the area of the ears. An alternative or additional way to reduce noise is active noise cancellation integrated in the headphones. In both cases, the noise reduction may be inappropriate or, in some situations, too strong e.g., may reduce or cancel desired sound, such as speech in the ambience of the headphone. To overcome this drawback, some headphones include a transparent mode that allows for transferring the ambient sound to the ears of a user wearing the headphone. However, it is difficult to identify situations when the headphone is supposed to switch into the transparent mode. It is thus desired to provide a simple and reliable way to automatically switch an ANC headphone into the transparent mode.

### SUMMARY

A method for operating at least two noise cancelling headphones, each headphone being switchable between a noise cancelling mode of operation and a transparent mode of operation, and each headphone comprising a microphone, a speech recognition processor and a wireless transceiver. The method includes monitoring sound in the ambience of each headphone picked up by the corresponding microphone for speech using the corresponding speech recognition processor; and monitoring the ambience of each headphone with the corresponding transceiver for a wireless mode control signal. The method includes switching the one of the headphones into the transparent mode of operation and sending the wireless mode control signal from the one of the headphones to at least one other of the headphones using the transceivers if speech is recognized in the picked up sound of one of the headphones. The method further includes switching the at least one other of the headphones from the noise cancelling mode of operation into the transparent mode of operation if the wireless mode control signal is received by the at least one other of the headphones from one of the other headphones.

A noise cancelling headphone includes two earphones, each earphone having a loudspeaker and an audio processor operatively coupled to the loudspeaker. The audio processor is switchable between a noise cancelling mode of operation and a transparent mode of operation. The headphone further includes a microphone configured to pick up sound in the ambience of the headphone; a speech recognition processor operatively coupled to the microphone and configured to monitor the picked up sound for speech; and a wireless transceiver configured to transmit and receive wireless mode control signals. The headphone further includes a mode controller operatively coupled to the speech recognition processor, the audio processor and the wireless transceiver. The mode controller is configured to switch the audio processor in the transparent mode of operation if either the speech recognition processor recognizes speech or the transceiver receives a first wireless mode control signal. The mode controller is further configured to broadcast a second wireless mode control signal if the speech recognition processor recognizes speech.

Other systems, methods, features and advantages will be, or will become, apparent to one with skill in the art upon examination of the following detailed description and appended figures. It is intended that all such additional systems, methods, features and advantages be encompassed within this description and within the scope of the invention, and that they be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a simplified illustration of a basic structure of an exemplary feedback type active noise cancellation (ANC) earphone;

FIG. 2 is a simplified illustration of a basic structure of an exemplary feedforward type ANC earphone;

FIG. 3 is a simplified illustration of a basic structure of an exemplary hybrid type ANC earphone;

FIG. 4 is a simplified illustration of an exemplary ANC headphone with two identical earphones that are switchable between an ANC mode of operation and a transparent mode of operation;

FIG. 5 is a block diagram illustrating in greater detail the signal flow in the ANC headphone shown in FIG. 4 and a mode controller controlling the modes of the headphone;

FIG. 6 is a simplified illustration of a memory mapping for storing word sequences applied in the headphone shown in FIGS. 4 and 5;

FIG. 7 is a simplified illustration of another memory mapping for storing word sequences applied in the headphone shown in FIGS. 4 and 5;

FIG. 8 is a flow chart illustrating a method for switching an ANC headphone from an ANC mode of operation into a transparent mode of operation; and

FIG. 9 is a flow chart illustrating a method for switching an ANC headphone from a transparent mode of operation into an ANC mode of operation.

### DETAILED DESCRIPTION

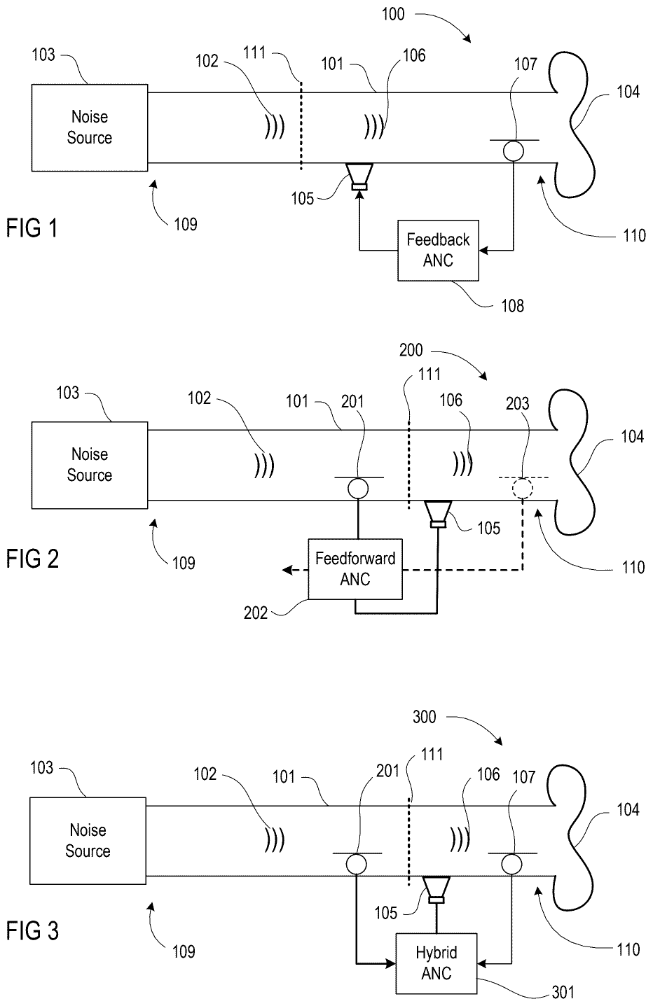

FIG. 1 is a simplified illustration of a basic structure of an exemplary feedback type active noise cancellation (ANC) earphone 100, in use. An acoustic path between a noise source 103 and a user's ear 104, represented by a channel 101, includes inter alia the ear canal, also known as external auditory meatus, and parts of the earphone 100 such as a shell 111. Noise, i.e., primary noise 102, is introduced into the channel 101 at a first end 109 by the noise source 103. The sound waves of the primary noise 102 travel through the channel 101 to a second end 110 of the channel 101 from where the sound waves are radiated, e.g., to the tympanic membrane of a user's ear 104 when the earphone 100 is attached to the user's head. In order to reduce or cancel the primary noise 102 in the channel 101, a sound radiating transducer, e.g., a (loud) speaker 105, introduces cancelling sound 106 into the channel 101. The cancelling sound 106 has an amplitude corresponding to or the same as the primary noise 102, however, of opposite phase. The primary noise 102 which enters the channel 101 is collected by an error microphone 107 and is processed by a feedback ANC processor 108 to generate a cancelling signal and is then emitted by the speaker 105 to reduce the primary noise 102. The error microphone 107 is arranged downstream of the speaker 105 and thus is closer to the second end 110 of the channel 101 than to the speaker 105, i.e., it is closer to the ear 104, in particular to its tympanic membrane. The shell 111 (only a section thereof is shown in FIG. 1) of the earphone 100 is disposed between the noise source at the first end 109 (which is outside the shell 111) and the speaker 105, the microphone 107 and the ear 104 at the second end 110 (which is inside the shell 111).

FIG. 2 is a simplified illustration of a basic structure of an exemplary feedforward type ANC earphone 200. The earphone 200 differs from the earphone 100 shown in FIG. 1 in that a (reference) microphone 201 is arranged between the first end 109 of the channel 101 and the speaker 105, instead of being arranged between the speaker 105 and the second end 110 of the channel 101 as is microphone 107 in the earphone 100 shown in FIG. 1. Furthermore, instead of the feedback ANC processor 108, a feedforward ANC processor 202 is connected between the microphone, i.e., microphone 201, and speaker 105. The feedforward ANC processor 202 as shown may be, for example, a non-adaptive filter, i.e., a filter with fixed transfer function, but can alternatively be adaptive in connection with an additional (error) microphone 203 to provide an extended feedforward type structure. The microphone 203 is disposed between the speaker 105 and the second end 110 of the channel 101 and controls (the transfer function of) the feedforward ANC processor 202. The microphone 201 is disposed acoustically outside the shell 111, e.g., on or in its outer surface, and the speaker 105, the optional microphone 203 and the ear 104 are disposed within the shell 111.

FIG. 3 is a simplified illustration of a basic structure of an exemplary hybrid type ANC earphone 300. A hybrid type ANC is a combination of a feedback and a feedforward ANC. Based on the headphones 100 and 200 described above in connection with FIGS. 1 and 2, the microphone 201 senses the primary noise 102 and its output is used to model the transmission characteristic of a path from the speaker 105 to the microphone 107, such that it matches the transmission characteristic of a path along which the primary noise 102 reaches the second end 110 of the channel 101. The primary noise 102 and sound radiated from the speaker 105 are sensed by the microphone 107, inverted in phase using the adapted (e.g., estimated) transmission characteristic of the signal path from the speaker 105 to the error microphone 107 and is then emitted by the speaker 105 disposed between the two microphones 201 and 107, thereby reducing the undesirable noise at the user's ear 104. Signal inversion, transmission path modeling (estimation) and, as the case may be, adaptation are performed by a hybrid ANC processor 301. For example, the hybrid ANC processor 301 may include a feedforward processor similar to the feedforward ANC processor 202 shown in FIG. 2 to process the signal from microphone 201, and a feedback processor similar to the feedback ANC processor 108 shown in FIG. 1 to process the signal from microphone 107. The microphone 201 is disposed acoustically outside the shell 111, and the speaker 105, the microphone 107 and the ear 104 are disposed within the shell 111.

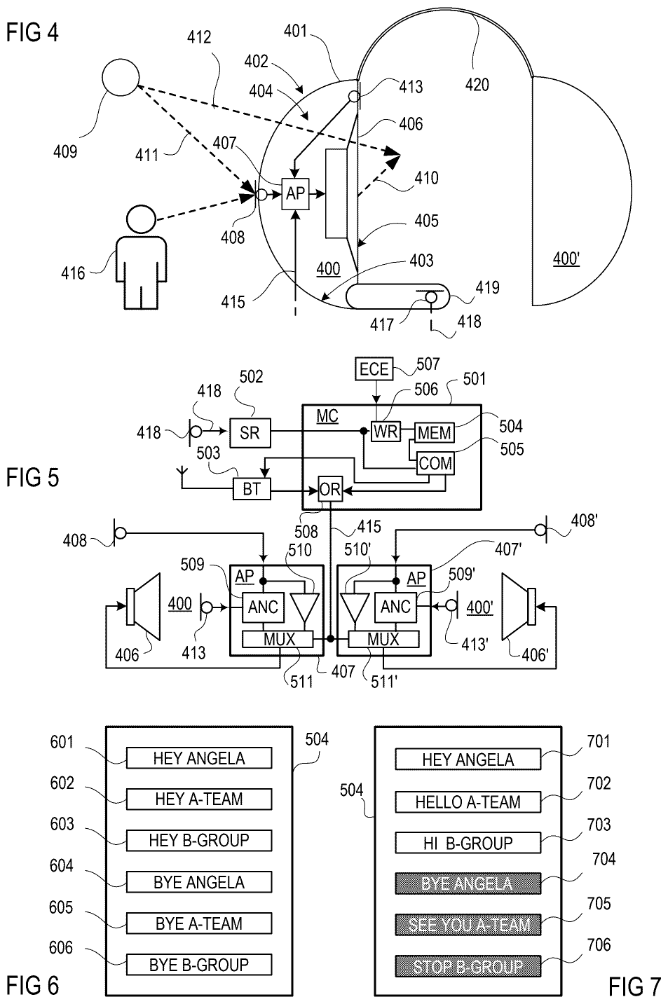

An exemplary earphone 400, which is part of an extended feedfoward (or hybrid) ANC headphone with two identical earphones 400, 400′, is shown in FIG. 4. The earphone 400 has a rigid cup-like shell 401 with an inner, e.g., convex surface 402, and an outer, e.g., concave surface 403. The shell 401 encompasses a cavity 404 with an opening 405. An electro-acoustic transducer for converting electrical signals into sound, such as a speaker 406, is disposed in the opening 405 of the cavity 404 and broadcasts to an ear of a user (not shown) sound 410 corresponding to an electrical output signal provided by an audio processor (AP) 407. The audio processor 407 may be supplied with an electrical reference signal from a (reference) microphone 408, which picks up sound at a certain position on the convex surface 402 of the shell 401 to provide a reference signal.

In the present example, a first portion 411 of noise emitted by a noise source 409 is picked-up by the microphone 408 while a second portion 412 reaches the ear of the user (not shown) wearing the headphones. The second portion 412 is acoustically altered, e.g., frequency dependent attenuated, by the earphone 400, but is still audible. The noise picked-up by the microphone 408, thus, corresponds somewhat to the noise perceived by the user, but is not identical. To achieve that the sound generated by the speaker 406, which corresponds to the first portion 411 picked-up by the microphone 408, actually destructively interferes with the altered second portion 412 of the noise from the noise source 409, the electrical signal provided by the microphone 408 is filtered by the audio processor 407 to generate sound which is inverted, but which is otherwise almost identical to the second portion 412 of noise perceived by the user.

Instead of a feedforward type ANC structure having a single microphone disposed at the outer surface of the shell, a feedback, enhanced feedforward or hybrid type structure can be used in the earphones 400 and 400′, wherein the single or an additional microphone may be disposed within the shell or otherwise adjacent to the user's ear. In the headphone shown in FIG. 1, the audio processor 407 provides, for example, enhanced feedforward type (or hybrid type) active noise cancellation in connection with an (error) microphone 413. The additional microphone 413 is disposed close to the opening 405 with speaker 406 mounted therein, and thus close to the user's ear. The additional microphone 413 is used to provide an error signal for the audio processor 407 to allow for adaptive feedforward filtering and, thus, a better filter performance under varying conditions. The audio processor 407 is switchable between two modes of operation under the control of a mode control signal 415. In one of these, a noise cancelling mode, herein also referred to as ANC mode, the audio processor is operated as an ANC system as detailed above, i.e., it cancels the second portion 412 of the noise from the noise source 409. In a second mode, referred to as transparent mode, the audio processor 407 amplifies and, in some cases, bandpass filters, the signal from the microphone 408. The headphone may have another microphone 417 which is positioned to preferably pick up speech from a user (not shown) of the headphone and to provide a user speech signal 418. For example, the microphone 417 may be disposed in a mounting bracket 419 attached to the earphone 400. Additionally or alternatively, the microphone 408 or any other additional microphone may be employed to pick up the user's speech.

Referring to FIG. 5, a mode controller (MC) 501 is operatively coupled to the audio processor 407 of earphone 400 and an audio processor 407′ of earphone 401′ and provides the mode control signal 415 thereto. The mode controller 501 in connection with the microphone 408 (shown in FIG. 5) monitors the ambient sound (i.e., sound in the ambience of the headphone) for speech in general (not shown) or particularly for specific word sequences in the speech. In one example, speech in general, i.e., the presence of any speech, is detected using a simple voice activity detector and, if a voice activity is detected, the mode controller causes the earphone 400 and 400′ to switch into the transparent mode. In another example, the mode controller 501 uses dedicated speech recognition and compares recognized word sequences with at least two stored word sequences. Word sequences are a series of at least two individual words, and can be spoken or written. What is appropriate in each individual case depends on the context. For example, word sequences captured by the microphone are spoken word sequences, while word sequences stored in the memory are written, in particular digitally coded, word sequences. The mode controller 501 switches the audio processors 407 and 407′ from the ANC mode into the transparent mode when it identifies in the ambient sound one of the stored word sequences.

FIG. 5 shows in detail one possible signal flow structure for providing the mode control signal 415. Starting from the basic structure shown in FIG. 4, the headphone includes the two identical earphones 400 and 400′ with each having the speaker 406, 406′, the audio processor 407, 407′, the reference microphone 408, 408′, and the error microphone 413, 413′. Optionally, instead of two separate audio processors as shown, a single audio processor that operates the two earphones 400 and 400′ may be used. In this example, there is only one mode controller, the mode controller 501, which controls the mode of both audio processors 407 and 407′. The mode controller 501 may be disposed in one of the earphones 400 and 400′, or may be arranged outside the earphones 400 and 400′, e.g., in a headband 420 of the headphone shown in FIG. 4. Alternatively, two mode controllers, e.g., one per earphone, may be employed. It is noted that the two audio processors 407 and 407′ may also be disposed in one of or outside the earphones 400 and 400′.

The mode controller 501 receives recognized speech sequences from a speech recognition (SR) processor 502 that monitors the ambient sound, in particular, the speech from the user represented by the user signal 418, by means of the microphone 417. Instead of or additionally to the microphone 417, one of or both microphones 408 and 408′ earphones 400 and 400′ can be used. The mode controller 501 is further connected to a wireless communication transceiver for transmitting and receiving signals wirelessly, such as a Bluetooth (BT) interface 503 in order to wirelessly and bi-directionally communicate with other headphones of the same or a similar type. Instead of a Bluetooth interface any other wireless bi-directional interface may be used such as a WLAN compatible device, a simple radio transceiver as used for remote control or an optical infrared transceiver. The mode controller 501 includes a memory (MEM) 504, in which at least two word sequences are stored, and, e.g., a comparator (COM) 505 that compares recognized word sequences with word sequences stored in the memory 504 and to switch the audio processors 407 and 407′ from the ANC mode into the transparent mode, if the speech recognition processor 501 identifies in the ambient sound one of the word sequences stored in the memory 504.

Word sequences can be stored in the memory 504 by means of a write controller 506 included in the mode controller 501 which, when and as long as it is activated using an external control element (ECE) 507 such as a button or a switch, redirects word sequences recognized by the speech recognition processor 501 into the memory 504. When, for example, a button is used, a word sequence can be recorded as long as it is being pressed. The memory location in which the word sequences are stored may be selected by the user, e.g., via another specific button, or automatically (e.g., serially) by the write controller, as the case may be. An OR gate 508 OR-wires an output of the Bluetooth interface 503 and an output of the comparator 505 to provide the mode control signal 415. If either the Bluetooth interface 503, due to receiving a wireless mode control signal, or the comparator 505, due to identifying a stored word sequence in the ambient sound, want the audio processors 509 and 509′ to switch, they generate the mode control signal 415 that is transferred via the OR gate 508 to audio processors 509 and 509′. If the comparator 505 creates the mode control signal 415, it is not only sent to the audio processors 509 and 509′ but also to other headphones via a wireless mode control signal by means of the Bluetooth interface 503 in order to cause them to switch.

The audio processors 407 and 407′, each may include an ANC filter 509, 509′, which is in the present example an adaptive ANC filter of the extended feedforward type, an amplifier 510, 510′, and a multiplexer 511, 511′. The ANC filter 509, 509′ filters the signal from the reference microphone 408, 408′ in an adaptive manner so that the signal from the error microphone 413, 413′ approaches zero, which occurs when the sound from the speaker 406, 406′ completely cancels the second noise portion 412 (see FIG. 4). The amplifier 510, 510′, e.g., frequency-independently, amplifies the signal from the reference microphone 408, 408′, which corresponds to the ambient sound. The multiplexer 511, 511′ connects speaker 406, 406′ to either the ANC filter 509, 509′ or the amplifier 510, 510′ dependent on the mode control signal 415 from the mode controller 501, e.g., the its comparator 505. In the ANC mode, the ANC filter 509, 509′ drives the speaker 406, 406′, and, in the transparent mode, it is the amplifier 510, 510′ that drives the speaker 406, 406′.

The headphone switches back from the transparent mode into the ANC mode in an identical or similar manner as it does in the opposite direction. The mode controller 501 induces the audio processors 407, 407′ to switch back from transparent mode into ANC mode if, for example, the speech recognition processor 502 identifies in the ambient sound a specific keyword contained in the word sequence. As shown in FIG. 6, such a keyword may be, for example, “BYE”. In turn, another keyword, e.g., “HEY” may be used to identify the wish to switch from ANC mode into transparent mode. This means that when a word sequence contains the word “HEY”, the headphone switches into transparent mode, and when a word sequence contains “BYE”, it switches back. Further, the memory 504 may record a multiplicity of word sequences which identify the user per se and groups he or she is assigned to. If a word sequence contains “ANGELA”, only the headphone assigned to a user identified as Angela is switched back and forth. If a word sequence contains “ANGELA”, only the headphone of Angela is caused to switch. This may be achieved in that the mode controller sends no signal. If a word sequence contains “A-TEAM” or “B-GROUP”, for example, the headphones of all members of the respective group in a certain area defined by the broadcast range of the wireless signal are caused to switch. In this case, the mode controller 501 may address only the headphones of the respective group, e.g., by a specific code contained in the wireless signal.

The word sequence “HEY ANGELA” switches only Angela's headphone into the transparent mode. The word sequences “HEY A-TEAM” and “HEY B-GROUP” switch the headphones of (all) members of the group defined as A-Team and the headphones of (all) members of the group defined as B-Group, respectively, into the transparent mode, provided the members are at a distance to the speaker at which the spoken words can be clearly understood by the speech recognition processor 501. The word sequence “BYE ANGELA” switches Angela's headphone into the ANC mode. The word sequences “BYE A-TEAM” and “BYE B-GROUP” switch the headphones of (all) members of the group defined as A-Team and the headphones of (all) members of the group defined as B-Group, respectively, into the ANC mode, provided the members are at a suitable distance to the speaker. In this configuration, the word sequences can be stored in any of the available locations 601-606 in the memory 504.

Alternatively, the information in which direction the headphone should switch is not contained in the word sequence itself but in the location in which the word sequence is stored. FIG. 7 depicts an example in which word sequences “HEY ANGELA”, “HELLO A-TEAM” and “HI B-GROUP” are stored in locations 701-703 of the memory 504, and word sequences “BYE ANGELA”, “SEE YOU A-TEAM” and “STOP B-GROUP” are stored in locations 704-706. The locations 701-703 are defined to contain word sequences that are assigned to instructions for switching into the transparent mode. The locations 704-706 are defined to contain word sequences that are assigned to instructions for switching into the ANC mode. In this configuration, the comparator 505 not only looks for matching word sequences but also identifies the memory location (address) to determine which action should be taken. The word sequence “HEY ANGELA” switches only Angela's headphone into the transparent mode. The word sequences “HELLO A-TEAM” and “HI B-GROUP” switch the headphones of (all) members of the group defined as A-Team and the headphones of the members of the group defined as B-Group, respectively, into the transparent mode, provided the members are at a suitable distance to the speaker. The word sequence “BYE ANGELA” switches only Angela's headphone into the ANC mode. The word sequences “SEE YOU A-TEAM” and “STOP B-GROUP” switch the headphones of (all) members of the group defined as A-Team and the headphones of (all) members of the group defined as B-Group, respectively, into the ANC mode, provided the members are at a suitable distance to the speaker. In this configuration, the word sequences that affect the transparent mode are stored in locations 701-703 of the memory 504, and the word sequences that affect the ANC mode are stored in locations 704-706 of the memory 504.

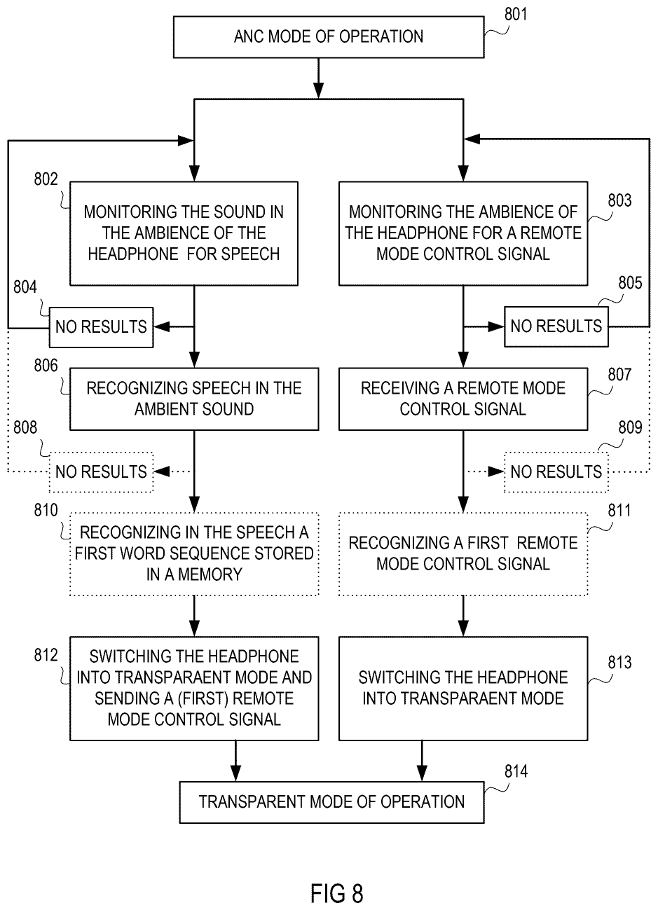

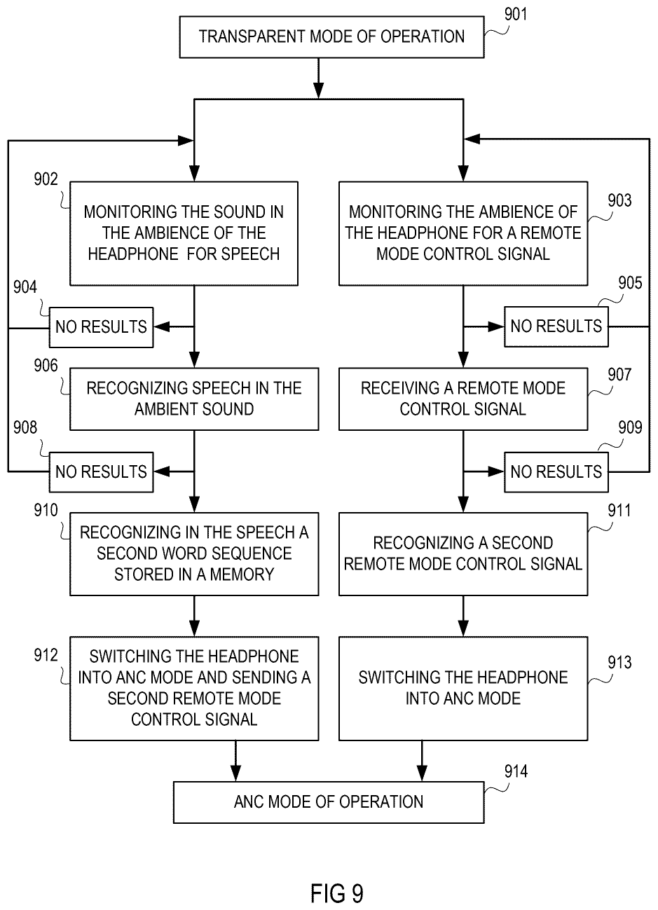

At least two noise cancelling headphones described above can be operated to allow acoustic communication between their users when wearing the headphones and in an ANC mode of operation. The method shown in FIG. 8 illustrates the signal flow of only one headphone but is identical with those of all other headphones that participate in the communication. Accordingly, the method starts with the headphone being initially in the ANC mode of operation (procedure 801). The headphone monitors the sound in the ambience of the headphone picked up by the corresponding microphone for speech using the corresponding speech recognition processor (procedure 802), and monitors the ambience of the headphone with the corresponding transceiver for a remote mode control signal (procedure 803). If there are no results (procedures 804, 805) from both monitoring operations, the headphone continues to monitor both subjects. If, however, speech is recognized in the picked up sound (procedure 806), the headphone is switched into the transparent mode of operation and sends a remote mode control signal to other headphones using the transceiver (procedure 812). Similarly, if a wireless mode control signal is received by the headphone from one of the other headphones, the headphone switches from the ANC mode of operation into the transparent mode of operation (procedure 813). This basic structure can be enhanced by comparing the recognized speech with predefined (stored) word sequences. Optionally, switching into the transparent mode of operation and sending a wireless mode control signal to other headphones (procedure 812) is only done if a first predefined word sequence is identified in the recognized speech (procedure 810). Otherwise, the headphone continues monitoring the ambient sound (procedures 808, 802). A further option is to switch into the transparent mode of operation only when a specific (coded) first wireless control signal is identified (procedure 811), otherwise the headphone continues with monitoring the ambience for a wireless mode control signal (procedures 809, 802).

Similarly, before switching back into the ANC mode, the headphone is initially in the transparent mode of operation (procedure 901). The headphone monitors the sound in the ambience of the headphone picked up by the corresponding microphone for speech using the corresponding speech recognition processor (procedure 902), and monitors the ambience of the headphone with the corresponding transceiver for a wireless mode control signal (procedure 903). If there are no results (procedures 904, 905) from both monitoring operations, the headphone continues to monitor both subjects. If, however, speech is recognized in the picked up sound (procedure 806), the method proceeds to the next step, which is comparing the recognized speech with predefined (stored) word sequences. Switching into the transparent mode of operation and sending a second wireless mode control signal to other headphones (procedure 912) is only done if a second predefined (stored) word sequence is identified in the recognized speech (910). Otherwise, the headphone continues monitoring the ambient sound (procedures 908, 902). Similarly, if a wireless mode control signal is received from one of the other headphones, the headphone proceeds to assess the wireless control signal. It switches into the ANC mode of operation only when a specific second wireless control signal is identified (procedure 911), otherwise the headphone continues monitoring the ambience for wireless mode control signals (procedures 909, 902).

If speech at one of the headphones is recognized, all headphones of the group located within the range of the wireless mode control signal are switched into the transparent mode. In another example, the communication within a group of at least two headphones may proceed as follows: All headphones in the group are in the ANC mode. One user speaks a first specific word sequence and all headphones of the group, including its own, are switched into the transparent mode. A similar procedure allows switching back to ANC mode with a specific second word sequence. The reception range of the wireless mode control signal (distance between transmitter and receiver) may be adjustable to avoid interference with other systems or groups of headphones. With an adjustable range, the number of participating headphones can be limited to headphones within the given range. Furthermore, when the user of the headphone is listening to music, it may be switched off or damped during the transparent mode and played at full volume in the noise cancelling mode. Although an active noise cancelling headphone has been described, the headphone may alternatively or additionally include passive noise suppression.

The method described above may be encoded at least partly in a computer-readable medium such as a CD ROM, disk, flash memory, RAM or ROM, an electromagnetic signal, or other machine-readable medium as instructions for execution by a processor. Alternatively or additionally, any type of logic may be utilized and may be implemented as analog or digital logic using hardware, such as one or more integrated circuits (including amplifiers, adders, delays, and filters), or one or more processors executing amplification, adding, delaying, and filtering instructions; or in software in an application programming interface (API) or in a Dynamic Link Library (DLL), functions available in a shared memory or defined as local or remote procedure calls; or as a combination of hardware and software.

The method may be implemented by software and/or firmware stored on or in a computer-readable medium, machine-readable medium, propagated-signal medium, and/or signal-bearing medium. The media may comprise any device that contains, stores, communicates, propagates, or transports executable instructions for use by or in connection with an instruction executable system, apparatus, or device. The machine-readable medium may selectively be, but is not limited to, an electronic, magnetic, optical, electromagnetic, or infrared signal or a semiconductor system, apparatus, device, or propagation medium. A non-exhaustive list of examples of a machine-readable medium includes: a magnetic or optical disk, a volatile memory such as a Random Access Memory “RAM,” a Read-Only Memory “ROM,” an Erasable Programmable Read-Only Memory (i.e., EPROM) or Flash memory, or an optical fiber. A machine-readable medium may also include a tangible medium upon which executable instructions are printed, as the logic may be electronically stored as an image or in another format (e.g., through an optical scan), then compiled, and/or interpreted or otherwise processed. The processed medium may then be stored in a computer and/or machine memory.

The systems may include additional or different logic and may be implemented in many different ways. A controller may be implemented as a microprocessor, microcontroller, application specific integrated circuit (ASIC), discrete logic, or a combination of other types of circuits or logic. Similarly, memories may be DRAM, SRAM, Flash, or other types of memory. Parameters (e.g., conditions and thresholds) and other data structures may be separately stored and managed, may be incorporated into a single memory or database, or may be logically and physically organized in many different ways. Programs and instruction sets may be parts of a single program, separate programs, or distributed across several memories and processors.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices. The described methods and associated actions may also be performed in various orders in addition to the order described in this application, in parallel, and/or simultaneously. The described systems are exemplary in nature, and may include additional elements and/or omit elements.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects.

While various embodiments of the invention have been described, it will be apparent to those of ordinary skilled in the art that many more embodiments and implementations are possible within the scope of the invention. In particular, the skilled person will recognize the interchangeability of various features from different embodiments. Although these techniques and systems have been disclosed in the context of certain embodiments and examples, it will be understood that these techniques and systems may be extended beyond the specifically disclosed embodiments to other embodiments and/or uses and obvious modifications thereof.

1. A method for operating at least two noise cancelling headphones, each headphone being switchable between a noise cancelling mode of operation and a transparent mode of operation, and each headphone comprising a microphone, a speech recognition processor and a wireless transceiver, wherein the method comprises:
monitoring sound in the ambience of each headphone picked up by the corresponding microphone for speech using the corresponding speech recognition processor; and
monitoring the ambience of each headphone with the corresponding transceiver for a wireless mode control signal; wherein
if speech is recognized in the picked up sound of one of the headphones, switching the one of the headphones into the transparent mode of operation and sending the wireless mode control signal from the one of the headphones to at least one other of the headphones using the transceivers; and
if the wireless mode control signal is received by the at least one other of the headphones from one of the other headphones, switching the at least one other of the headphones from the noise cancelling mode of operation into the transparent mode of operation.

2. The method of claim 1, further comprising switching the one of the headphones into the transparent mode of operation and sending a wireless mode control signal from the one of the headphones to at least one other of the headphones only if a first predefined word sequence is identified in the recognized speech.

3. The method of claim 2, further comprising switching the one of the headphones into the noise cancelling mode of operation and sending another wireless mode control signal from the one of the headphones to at least one other of the headphones if a second predefined word sequence is identified in the recognized speech, the other wireless mode control signal switching the at least one other of the headphones from the transparent mode of operation into the noise cancelling mode of operation.

4. The method of claim 3, further comprising storing in a memory at least one word sequence identified by the speech processor if and as long as a button is activated, the at least one stored word sequence includes at least one of the first predefined word sequence or the second predefined word sequence.

5. The method of claim 4, wherein the first predefined word sequence and the second predefined word sequence are each identified by a specific keyword contained in the respective word sequence.

6. The method of claim 4, wherein the first predefined word sequence and the second predefined word sequence are each identified by a predefined location in the memory.

7. The method of claim 2, further comprising additional predefined word sequences, wherein each additional predefined word sequence is assigned to a specific other headphone or a group of other headphones.

8. The method of claim 1, wherein the reception range of the wireless mode control signal is adjustable.

9. The method of claim 8, wherein if speech is recognized all headphones located within the range of the wireless mode control signal are switched into the transparent mode.

10. The method of claim 1, wherein the wireless mode control signal comprises an identifier code that identifies which of the other headphones is or are to be switched into the transparent mode.

11. A noise cancelling headphone, the headphone comprising:
two earphones, each earphone having a loudspeaker and an audio processor operatively coupled to the loudspeaker, the audio processor switchable between a noise cancelling mode of operation and a transparent mode of operation;
a microphone configured to pick up sound in the ambience of the headphone;
a speech recognition processor operatively coupled to the microphone and configured to monitor the picked up sound for speech;
a wireless transceiver configured to transmit and receive wireless mode control signals;
a mode controller operatively coupled to the speech recognition processor, the audio processor and the wireless transceiver, the mode controller being configured to switch the audio processor in the transparent mode of operation if either the speech recognition processor recognizes speech or the transceiver receives a first wireless mode control signal, and the mode controller being further configured to broadcast a second wireless mode control signal if the speech recognition processor recognizes speech.

12. The headphone of claim 11, wherein the mode controller is further configured to switch the one of the headphones into the transparent mode of operation and to make the wireless transceiver send the second wireless mode control signal only if a first predefined word sequence is identified in the recognized speech.

13. The headphone of claim 12, wherein the mode controller is further configured to switch the one of the headphones into the noise cancelling mode of operation and sending the second wireless mode control signal from the one of the headphones to at least one other of the headphones if a second predefined word sequence is identified in the recognized speech.

14. The headphone of claim 13, wherein the mode controller is further configured to store at least one word sequence identified by the speech recognition processor in a memory if and as long as a button is activated, the stored at least one word sequence including at least one of the first predefined word sequence and the second predefined word sequence.

15. The headphone of claim 11, wherein the reception range of the wireless mode control signal is adjustable.
